(19) United States
(12) Patent Application Publication
(10) Pub. No.: US 2014/0097239 A1
(43) Pub. Date: Apr. 10, 2014

(54) SYSTEM AND METHOD FOR USING 1D AND 2D BARCODES IN ELECTRICAL TROUBLESHOOTING AND SERVICE PARTS INFORMATION

(71) Applicant: AGCO Corporation, Duluth, GA (US)

(72) Inventors: Michael B. Bayliff, Mulvane, KS (US); Daniel J. Soldan, Hillsboro, KS (US); Timothy D. Buhler, Newton, KS (US)

(73) Assignee: AGCO Corporation, Duluth, GA (US)

(21) Appl. No.: 14/045,893

(22) Filed: Oct. 4, 2013

Related U.S. Application Data
(60) Provisional application No. 61/709,564, filed on Oct. 4, 2012.

(51) Int. Cl. G06F 17/30

(52) U.S. Cl. CPC G06F 17/30
USPC 235/375

(57) ABSTRACT

Barcodes, such as QR codes are strategically placed on the work vehicle in a location representative of an electrical system. Scanning the QR code with a QR scanner, smart phone or other device will take a user to the schematic location for the system and/or a list of systems in the area. Schematic details may be provided by electrical means via OEM diagnostic tool, web site or reference to a printed manual and page number. Alternately, from the schematic a user could scan a code to point them to a location on the work vehicle for system or component. In addition to QR codes on the work vehicle, QR codes and 1 dimensional codes could also be placed on components like harnesses, sensors, modules and the like to provide schematic location and assist in component detail, part numbers and ordering.

### CROSS REFERENCE TO RELATED APPLICATION

This application claims the benefit of U.S. Provisional Application No. 61/709,564, entitled SYSTEM AND METHOD OF USING 1D AND 2D BARCODES IN ELECTRICAL TROUBLESHOOTING AND SERVICE PARTS INFORMATION filed Oct. 4, 2012, which is hereby incorporated by reference in its entirety.

### BACKGROUND OF THE INVENTION

1. Field of Invention

This invention relates generally schematic drawings used to provide information about a machine system, and more particularly to using optical barcodes strategically placed on the machine in a location representative of an electrical system and scanning the optical barcode to locate a schematic location for the system and/or a list of systems in the area.

2. Description of Related Art

Electrical schematics provide a graphical representation of the circuits and systems of a machine. To the non-trained or unaccustomed, they can be a complex web of lines and symbols that add to the confusion associated with tracking down and fixing the problem. When diagnosing an electrical issue often times half the battle is finding the correct schematic sheet. There can be pages and pages of system level schematics, knowing what system a given sensor or connector may belong to is not always intuitive. Frustration could lead to trial and error methods of tracking down the problem, this adds cost, increased machine down-time and can unnecessarily affect the perceived quality of the machine. To increase the productivity of the technician or operator, a systematic approach to troubleshooting is the best approach to find the problem fast and fix it right the first time.

Historically extensive training would be required to train a technician on the systems of the machine, what components are in a given system, how to locate and order parts in a parts book. It is a manual process that relies on technician/operators to have extensive knowledge on the machine/system in question. Alternatively it could lead a technician to jump from page to page, system to system then replace and hope they quickly find the problems and correct it the first time.

Once the faulty component has been located, obtaining part numbers and ordering new parts can be an equally exasperating process. Frequently a technician may be located in the field and not able to access parts books or parts programs. The schematics may not contain enough detail on a component; component views or operating characteristics may go a long way in fixing the problem.

It would be desirable to have a system and method that eliminates the guess work and frustration in finding the correct system schematic or component by taking the user directly to the schematic or suspect component.

### OVERVIEW OF THE INVENTION

In one embodiment, optical barcodes, such as QR codes, are strategically placed on the machine in a location representative of an electrical system. Scanning the QR code with a QR scanner, smart phone or other device takes a user to a schematic for the electrical system and/or a list of systems in the area. In one embodiment, schematic details are provided by electrical means using a diagnostic tool, a web site or a reference to a printed manual and page number. Alternately, from the schematic, a user scans a code to point them to a location on the machine for an electrical system or component. In addition to QR codes on the machine, QR codes are placed on components like harnesses, sensors, modules and the like to provide schematic location and assist in component detail, part numbers and ordering.

Another aspect of the invention is a method for troubleshooting a system on a work vehicle having a plurality of different systems. The method includes applying a plurality of optical barcodes to strategic places on the work vehicle, each optical barcode associated with one of the plurality of different systems on the work vehicle. The method also includes scanning the barcode associated with the system to be troubleshot with a barcode scanner to call up a schematic associated with the system to be troubleshot.

These and other features and advantages of this invention are described in, or are apparent from, the following detailed description of various example embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic drawing of a first embodiment of using optical barcodes in a service manual to access electronic tools;

FIG. 2 is a schematic drawing of a second embodiment of using optical barcodes on a component to access electronic tools; and

FIG. 3 is a schematic drawing of a first embodiment of using optical barcodes on a machine to access electronic tools.

Corresponding reference characters indicate corresponding parts throughout the views of the drawings.

### DESCRIPTION OF EXAMPLE EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

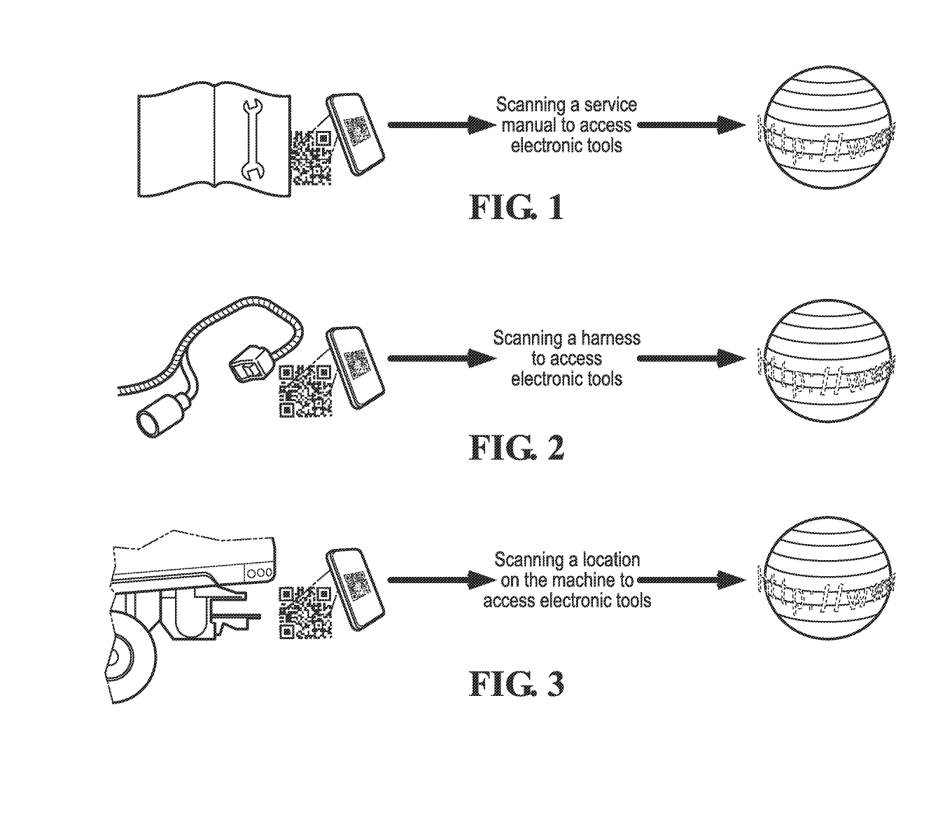

Referring now to FIG. 1, information about a system 10, such as an electrical or mechanical system 10 on a work vehicle 12 is obtained using an optical barcode 14 and a barcode reader 16. The optical barcode 14 is strategically placed on the work vehicle 12 in a location representative of the electrical system 10. As is known in the art, a barcode 14 is an optically machine-readable label that is attached to an item and that records information related to that item. By the term “two-dimensional optical code” a set of graphic marks is intended, located on a label or directly on the work vehicle 12, by means of which information is associated with a surface divided into white, black or colored cells, arranged in one or more directions. One of the most common two-dimensional optical codes is commonly referred to as a Quick Response Code or QR Code, however other two-dimensional codes of different symbologies and/or by the manner of coding data may be used without departing from the scope of the invention. The invention will be described in terms using a QR code 14, but it is to be understood that other 2D and 1D optical codes may also be used.

The QR code 14 strategically placed on the work vehicle 12 is scanned with a QR scanner 16, such as a smart phone or other device. Scanning the QR code takes a user to electronic tools 18, such as a schematic for the applicable system 10 and/or a list of systems in the area. In one embodiment, schematic details are provided by electrical means using a diagnostic tool, a web site or a reference to a printed manual and page number. Alternately, as shown in FIG. 2, from a schematic 20, a user scans a QR code 14 to point them to a location on the work vehicle 12 for the electrical system 10 or component. In addition to QR codes on the work vehicle 12, QR codes are placed on components like harnesses, sensors, modules and the like to provide schematic location and assist in component detail, part numbers and ordering.

Turning now to FIG. 3, in another embodiment the QR code 14 is placed directly on a component 22, such as a connector or wiring harness that is to be used in the electrical system 10 on the work vehicle 12. During schematic and wire harness creation, the QR code 14 is generated for each connector/terminal in the harness. The QR code 14 may represent an internet link to the supplier web site for the given connector 22. In one embodiment, a web tool would be created, such as by an OEM, that links to detailed information about the component. Using a smart phone or other code reader 16 to interface to the OEM web tool, a technician in the field could order service parts, look up part numbers, view assembly and de-pinning process, view connector pin out, connector terminal function or simply retrieve component information and views. From the OEM, tool a technician can jump to schematic pages that contain the bar code using hyperlink in the OEM tool. The QR codes generated would be placed on a tag/label near each connector/terminal in the harness. Component tables in the schematics would also contain the codes. This process would allow the user to troubleshoot and find connector/terminal information starting at either the schematic or the harness level. In addition to a code at the component level, a harness level code would be generated that would link to a BOM and other detailed information of the harness. From the harness level, a technician could order service spares or jump to individual component pages. In all cases the code could be standardized at OEM service parts centers and dealer for better inventory control.

In one embodiment, an electronic diagnostic tool, such as one provided by an OEM, can be used when servicing the work vehicle 12. Electrical schematics and diagnostic flow charts are placed in the diagnostics tool to aid the technician in troubleshooting and fault correction. For diagnostic tools with a built in code reader, the QR code will be scanned and the tool could take the technician to a page that allows them to jump directly to the applicable diagnostic flow charts or schematic pages. Once the fault is detected, replacement parts could be ordered directly from the tool or simply show the applicable code for the component to be scanned with an external reader. If a tablet does not have a built in code reader, the technician could use a smart phone or other code reader to take them to the web tool. The web tool would contain a code they could simply type into the diagnostic tool that would take them to the same page indicated above.

In addition to component level QR codes, a QR code would be generated for an electrical system 10, for example, a starting circuit for the work vehicle 12. The QR code is placed on a label and affixed to the work vehicle 12 in an area of the applicable system 10. The QR code takes the technician to the web tool to allow them to view service parts for the system 10 or a diagnostic flow chart to step them through the fault detection process. In the example of a starting circuit, the QR code is placed on or near the starter motor. When the technician has a problem with the starting circuit, he would scan the QR code to jump to the starting diagnostic flow chart. One QR code could be generated with each electrical system category.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

1. A method for troubleshooting a system on a work vehicle comprising a plurality of different systems, the method comprising:
applying a plurality of optical barcodes to strategic places on the work vehicle, each optical barcode associated with one of the plurality of different systems on the work vehicle; and
scanning the barcode associated with the system to be troubleshot with a barcode scanner to access an electronic tool associated with the system to be troubleshot.

2. The method of claim 1 wherein accessing the electronic tool comprises accessing diagnostic flow charts or schematic pages associated with the system.

3. The method of claim 1 wherein accessing the electronic tool comprises accessing a service part ordering tool.

4. The method of claim 1 wherein the electronic tool is provided by electrical means via an OEM diagnostic tool.

5. The method of claim 1 wherein the electronic tool is provided by electrical means via link to a web site.

6. The method of claim 1 wherein the electronic tool is provided by reference to a printed manual and page number.

7. The method of claim 1 wherein the barcode is a one-dimensional barcode.

8. The method of claim 1 wherein the barcode is a two-dimensional barcode.

9. The method of claim 6 wherein the barcode is a QR code.
